(19) United States
(12) Patent Application Publication
(10) Pub. No.: US 2024/0258560 A1
(43) Pub. Date: Aug. 1, 2024

(54) NONAQUEOUS ELECTROLYTE SECONDARY BATTERY

(71) Applicant: NISSHA Co., Ltd., Kyoto-shi, Kyoto (JP)

(72) Inventors: Keiichiro UENAE, Nakagyo-ku, Kyoto-shi, Kyoto (JP); Junji AKIMOTO, Tsukuba-shi, Ibaraki (JP); Hideaki NAGAI, Tsukuba-shi, Ibaraki (JP); Seiichi YANO, Sakai-ku, Sakai-shi, Osaka (JP)

(21) Appl. No.: 18/564,096

(22) PCT Filed: May 18, 2022
(86) PCT No.: PCT/JP2022/020611

§ 371 Date: Nov. 26, 2023

(30) Foreign Application Priority Data
May 28, 2021 (JP) 2021-090485

(51) Int. Cl. H01M 10/0525; H01M 4/02; H01M 4/48; H01M 4/505; H01M 4/525; H01M 4/62

(52) U.S. Cl. CPC H01M 10/0525; H01M 4/483; H01M 4/622; H01M 4/625; H01M 2004/021; H01M 2004/027; H01M 4/505; H01M 4/525

(57) ABSTRACT

Disclosed is a nonaqueous electrolyte secondary battery having improved electron conductivity of an electrode and improved input and output characteristics. The nonaqueous electrolyte secondary battery includes a positive electrode containing a lithium-containing transition metal composite oxide as an active material, a negative electrode, and a nonaqueous electrolyte. The negative electrode contains titanium oxide particles that are particles of titanium oxide represented by general formula H₂Ti₁₂O₂₅, a binder, and 0.3-5.0 weight percent of single wall carbon nanotubes with respect to the titanium oxide. The titanium oxide particles have a secondary particle size D50 of 1 to 15 μm and a secondary particle size D90 of 50 μm or less.

### CROSS-REFERENCE TO RELATED APPLICATIONS

This application is the U.S. National Stage of International Application PCT/JP2022/020611 filed May 18, 2022, the contents of which are incorporated herein by reference and the priority benefit of which is claimed. The PCT application is based on Japanese Application 2021-090485 filed May 28, 2021, the contents of which are incorporated herein by reference and the priority benefit of which is claimed.

### TECHNICAL FIELD

The claimed invention relates to a nonaqueous electrolyte secondary battery such as a lithium ion secondary battery.

### BACKGROUND

The lithium ion secondary battery is widely used for portable devices such as a personal computer and a cellular phone. In recent years, large batteries are developed for electric vehicles (hereinafter may be referred to as EVs), industrial robots, megasolars, or stationary power supplies for home use, and it is expected that the market will be expanded in the future. In such a new market, particularly for EVs, characteristics required to the lithium ion secondary battery are higher capacity. However, at present, in a conventional combination of a lithium transition metal composite oxide positive electrode and a graphite negative electrode, capacity of battery has already reached a limit. Also in development of a high-voltage positive electrode and a high capacity Si compound negative electrode, it is not commercialized yet because it has not obtained a cycle reaching a capacity equal to or higher than that of current batteries. In addition, development of a new type battery such as a solid electrolyte battery or an organosulfur/Li metal battery is proceeding recently, but there are many problems to solve, including productivity, and commercialization in a large size is still on the way.

Concerning the lithium ion secondary battery, as one of infrastructures, development of charging environment including noncontact charging is proceeding. Therefore, by developing a lithium ion secondary battery having good input and output characteristics, if charging is completed in a short time, the problem of higher capacity described above can be solved.

For instance, as Toshiba's SCiB (registered trademark) described in Toshiba Review Vol. 71, No. 2, pp. 44, a battery is developed, which supports charging in 20 C and can be charged to nearly 100% in a few minutes. In addition, in this battery, an active material represented by general formula Li₄Ti₅O₁₂ disclosed in JP-A-H6-275263, for example, is adopted in a negative electrode, and there is no problem of lithium deposition in normal discharge and charge, which is a problem of conventionally adopted graphite, because the material has a discharge and charge potential of 1.5V (vs. Li/Li⁺) or more. In particular, high input causes high overvoltage, and hence the above problem is important. On the other hand, because Li₄Ti₅O₁₂ has low electron conductivity, it is necessary to add a conductive agent such as graphite or carbon black to the electrode. There is a problem that Li₄Ti₅O₁₂ has an inherent theoretical capacity of 175 mAh/g, which is lower than 372 mAh/g that is a theoretical capacity of graphite, and further the capacity is extremely decreased by adding the conductive agent.

### PRIOR ART

### Patents

JP-A-H6-275263
JP-A-2008-255000
JP-A-2020-117416
Japanese Patent No. 6030708

### NON-PATENT REFERENCE

Toshiba Review Vol. 71, No. 2, pp. 44

### SUMMARY OF INVENTION

As a material for solving the problem of the negative electrode material described above, for example, JP-A-2008-255000 describes a new titanium oxide represented by general formula H₂Ti₁₂O₂₅. The discharge and charge potential of H₂Ti₁₂O₂₅ is approximately 1.5V (vs. Li/Li⁺), which is as high as that of a conventional spinel lithium titanate Li₄Ti₅O₁₂, and hence the problem of lithium deposition can be avoided. In addition, JP-A-2008-255000 describes that Li₄Ti₅O₁₂ has a theoretical capacity of approximately 175 mAh/g while H₂Ti₁₂O₂₅ has a capacity of approximately 200 to 230 mAh/g.

Furthermore, JP-A-2020-117416 describes that a new method of producing H₂Ti₁₂O₂₅ can improve the capacity up to 270 to 320 mAh/g. Furthermore, Japanese Patent No. 6030708 describes a new titanium oxide represented by general formula TiNb₂O₇. Japanese Patent No. 6030708 describes that TiNb₂O₇ can obtain a capacity equal to that of graphite.

However, in either negative electrode material, the problem of low electron conductivity of the active material is not solved.

Therefore, it is an object of the claimed invention to improve electron conductivity of an electrode and hence to improve input and output characteristics in a nonaqueous electrolyte secondary battery.

Hereinafter, a plurality of embodiments are described as means for solving the problem. These embodiments can be arbitrarily combined as necessary.

A nonaqueous electrolyte secondary battery according to one aspect of the claimed invention includes a positive electrode containing a lithium-containing transition metal composite oxide as an active material, a negative electrode, and a nonaqueous electrolyte. The negative electrode contains titanium oxide particles that are particles of titanium oxide represented by general formula H₂Ti₁₂O₂₅, a binder, and 0.3-5.0 weight percent of single wall carbon nanotubes with respect to the titanium oxide. The titanium oxide particles have a secondary particle size D50 of 1 to 15 μm and a secondary particle size D90 of 50 μm or less.

The nonaqueous electrolyte secondary battery may be configured so that the titanium oxide particles can have a specific surface area of 15 to 150 m²/g.

According to the nonaqueous electrolyte secondary battery of the claimed invention, the electron conductivity of the electrode is improved, and hence the input and output characteristics are improved.

### DESCRIPTION OF EMBODIMENTS

### (1) Overall Structure

A nonaqueous electrolyte secondary battery according to an embodiment of the claimed invention includes a positive electrode containing a lithium-containing transition metal composite oxide as an active material, a negative electrode, and a nonaqueous electrolyte. The negative electrode contains titanium oxide particles that are particles of titanium oxide represented by general formula H₂Ti₁₂O₂₅, a binder, and 0.3-5.0 weight percent of single wall carbon nanotubes with respect to the titanium oxide. It is preferred that a secondary particle size D50 is 1 to 15 μm and a secondary particle size D90 is 50 μm or less.

In H₂Ti₁₂O₂₅ used in this embodiment, primary particles are granulated to form secondary particles. If the secondary particle size D50 is less than 1 μm, dispersing quality is deteriorated when producing electrode paste, and it is necessary to excessively add the binder and/or solvent, resulting in relative reduction of active material concentration. On the other hand, if the secondary particle size D50 is more than 15 μm, or if D90 is more than 50 μm, smoothness of the electrode sheet is impaired, and a ratio of H₂Ti₁₂O₂₅ is increased, which is not affected by contribution of electron conductivity due to carbon coating, and hence characteristic may be deteriorated.

H₂Ti₁₂O₂₅ has a large specific surface area as a negative electrode active material so as to contribute to improvement of utilization ratio, but has a small electron conductivity, and hence it is considered to add more conductive agent such as graphite or carbon black. Therefore, for the purpose of improving input and output, the electrode was studied in which an existing conductive agent was added, such as graphite, carbon black, ketjen black, vapor grown carbon fiber (VGCF (registered trademark)), or multi-walled carbon nanotube. As a result, it was found that input and output were improved by increasing the amount of the agent as largely as 10 weight percent or more. However, on the other hand, because the agent has a large specific surface area, mechanical strength of the electrode could not be obtained without increasing the amount of the binder too. In general, binder such as polyvinylidene fluoride (PVDF), polyimide, styrene-butadiene rubber (SBR), carboxymethyl cellulose (CMC), or polyacrylic acid has low electron conductivity, and hence its increase causes decrease in the input and output. As a result of this study, it was found that input and output characteristics was dramatically improved by using single wall carbon nanotubes as the conductive agent with a lower additive amount than the existing conductive agent described above, so as to obtain a capacity that could not obtained by the conventional agent. This reason is considered that the single wall carbon nanotubes cover particle surfaces of H₂Ti₁₂O₂₅ having a large specific surface area so that electron conductivity can be effectively improved. A common conductive agent such as carbon black exists not only on the surface of the active material but also in spaces between the active material largely, and hence it is necessary to increase the additive amount thereof in order to obtain sufficiently high surface conductivity described above. Multi-walled carbon nanotubes exist mostly on the surface of the active material but they have short fiber lengths, and hence it is necessary to add them in a large amount in order to improve surface conductivity, resulting in little contribution to conductivity between the active material. In contrast, the single wall carbon nanotubes have long fiber lengths, and it is considered that they can contribute to not only the surface conductivity but also conductivity between the active material, with small amount, as described above, and that desired characteristics can be satisfied with low additive amount. Furthermore, if the specific surface area is as small as less than 15 m²/g, there is no problem with small surface existence probability of the conductive agent, but in the case of H₂Ti₁₂O₂₅ particles of this embodiment having a large specific surface area, it is considered that conductivity between the primary particles constituting the active material is reflected on input and output characteristics when charged and discharged with high current density. Using the single wall carbon nanotubes, even when the additive amount thereof was decreased and hence the binder amount was decreased, the mechanical strength of the electrode was not lowered. Therefore, by containing or carrying the single wall carbon nanotubes when H₂Ti₁₂O₂₅ was synthesized, the input and output characteristics were improved without adding them when producing the electrode, and the input and output characteristics were improved more than the case where they were added to ordinary H₂Ti₁₂O₂₅.

As a method for containing or carrying the single wall carbon nanotubes in H₂Ti₁₂O₂₅, there is a method of mixing and adhering the single wall carbon nanotubes to H₂Ti₁₂O₂₅ in powder by a disperser or by mechanochemical processing, or a method of wet mixing the single wall carbon nanotubes in the process where H₂Ti₁₂O₂₅ or proton exchanger of lithium titanate obtained in the previous process is slurried when producing H₂Ti₁₂O₂₅, and simultaneously drying them, or other method. In order to allow the single wall carbon nanotubes to disperse and adhere to particle surfaces of H₂Ti₁₂O₂₅ more uniformly, it is preferred to adopt the method of wet mixing in the slurried state and simultaneously drying them.

In the nonaqueous electrolyte secondary battery having the structure described above, electron conductivity of an electrode is improved, and input and output characteristics are improved.

### (2) Negative Electrode in Overall Structure

The specific surface area of the active material used in the negative electrode according to this embodiment is not particularly limited. However, as described later, it is preferred to form the negative electrode described above by using the binder containing the active material having a specific surface area of 15 to 150 m²/g. H₂Ti₁₂O₂₅ has low electron conductivity similarly to Li₄Ti₅O₁₂, and has a specific surface area that is a few times larger than that of Li₄Ti₅O₁₂. In addition, H₂Ti₁₂O₂₅ has a surface area that is ten times or more larger than that of commonly used graphite.

In a preferred producing process of H₂Ti₁₂O₂₅, as described later, it is preferred to mix titanium raw material and lithium raw material so as to synthesize lithium titanate precursor at relatively low temperature by a hydrothermal synthesis method, and in order to sufficiently complete the reaction, it is preferred to use titanium compound as the raw material that has a particle size of 5 to 200 nm. The obtained H₂Ti₁₂O₂₅ contains primary particles of the remaining shape of titanium compound as the raw material, and has a specific surface area of 15 to 150 m²/g.

### (3) Detailed Structure

(3-1) Method for Synthesizing H₂Ti₁₂O₂₅ and Method for Mixing Single wall Carbon

### Nanotubes

A method for synthesizing H₂Ti₁₂O₂₅ and a method for mixing the single wall carbon nanotubes are described below.

(3-1-1) Synthesis of H₂Ti₁₂O₂₅

The method for synthesizing H₂Ti₁₂O₂₅ used in this embodiment includes a lithium titanate synthesis process, a lithium titanate heat treatment process, a lithium/proton exchange process, and a proton exchanger heat treatment process.

In the lithium titanate synthesis process, titanium raw material containing titanium compound and lithium raw material containing lithium compound are mixed, and crystal growth in the mixture is performed by heat treatment or the like, so that lithium titanate can be obtained. More specifically, a hydrothermal synthesis method or the like is used to perform the crystal growth in the mixture containing the titanium raw material and the lithium raw material.

The titanium raw material is not particularly limited as long as it contains titanium compound, and can be, for example, an oxide such as TiO, Ti₂O₃, or TiO₂, a titanium oxide hydrate such as TiO(OH)₂ or TiO₂·xH₂O (x is arbitrary), an inorganic titanium compound such as titanium chloride or titanium sulfate, an organic titanium compound such as titanium isopropoxide or titanium butoxide, or the like. Among them, the titanium oxide or the titanium oxide hydrate is particularly preferred.

If the titanium compound is particulate, it is preferred to have a primary particle size of 5 to 200 nm. By selecting appropriate reaction conditions in the hydrothermal synthesis method, H₂Ti₁₂O₂₅ can be synthesized while maintaining a primary particle shape of the titanium raw material. In addition, if the titanium compound has a primary particle size less than 5 nm, particle aggregation is strong, and an unreacted portion may remain unless the aggregation is resolved. Further, in the case where the primary particle size is more than 200 nm, the reaction may not proceed inside the particles.

The lithium raw material is not particularly limited as long as it contains lithium compound, and can be, for example, an oxide such as Li₂O or Li₂O₂, a salt such as Li₂CO₃ or LiNO₃, or a hydroxide such as LiOH. Among them, the hydroxide such as LiOH is particularly preferred.

The mixture containing the titanium raw material and the lithium raw material may be obtained by dry mixing of the titanium raw material and the lithium raw material, or by dissolving or suspending the titanium raw material and the lithium raw material in liquid such as water or ethanol.

The lithium titanate synthesis process includes the step of crystal growth by heat treatment of the mixture containing the aforementioned titanium raw material and lithium raw material. The method of crystal growth can be a solid reaction method that is a typical method for synthesizing ceramic fine particles, or a liquid phase method such as a precipitation method, a sol-gel method, or a hydrothermal synthesis method. Among them, the hydrothermal synthesis method is particularly preferred.

When using the hydrothermal synthesis method for crystallization, it is preferred to use TiO₂ as the titanium raw material, and to use LiOH. H₂O as the lithium raw material. Furthermore, it is preferred that the weight ratio of the lithium raw material to the titanium raw material is one or more (the substance ratio of the lithium raw material to the titanium raw material is approximately 2.3 or more). Reaction temperature and reaction time of the hydrothermal synthesis are not particularly limited, but it is preferred to adopt a reaction temperature of 150 degrees Celsius or higher and a reaction time of three hours or more.

The crystal growth by the hydrothermal synthesis produces lithium titanate. The lithium titanate can be Li₂TiO₃, Li₂Ti₂O₄, LiTi₂O₄, Li₄Ti₅O₁₂, or the like. Among them, Li₂TiO₃ is preferred.

The lithium titanate obtained by the hydrothermal synthesis can be collected by a known method such as filtration, natural settling, or centrifugation. The collected lithium titanate contains unreacted LiOH, and hence it is preferred to perform washing. The solvent used for washing may be water or a low concentration of inorganic acid such as hydrochloric acid or nitric acid. The lithium titanate after washing is dried by a known method using a box type dryer, a spray dryer, or the like.

In the lithium titanate heat treatment process, the lithium titanate obtained by the lithium titanate synthesis process is heat treated. By this heat treatment, solvent molecules infiltrating into the crystal structure of the lithium titanate are removed, and the lithium titanate, whose main phase is Li₂TiO₃ having a rock salt type crystal structure, is partially changed to Li₂TiO₃ having a monoclinic crystal structure. Having the complex composite crystal structure, the lattice site arrangement of titanium atoms is irregular compared with Li₂TiO₃ having the single structure of the rock salt type crystal structure or the monoclinic crystal structure. Therefore, compared with Li₂TiO₃ having the single structure, Li₂TiO₃ having this complex structure is hardly changed to titanium dioxide such as anatase or rutile in a dehydration process in a subsequent heat treatment process of the proton exchanger of lithium titanate.

The lithium titanate heat treatment process is performed in the air or in an inert gas atmosphere such as nitrogen or argon. It is preferred that the heat treatment temperature is 100 degrees Celsius or higher and 600 degrees Celsius or lower. A firing temperature lower than 100 degrees Celsius makes it difficult for the rock salt type crystal structure to phase change to the monoclinic crystal structure. A firing temperature higher than 600 degrees Celsius allows most rock salt type crystal structure to change to the monoclinic crystal structure. It is more preferred that the heat treatment temperature is 200 to 500 degrees Celsius. In addition, the heat treatment time is preferably 0.5 to 100 hours, and more preferably 1 to 30 hours.

In the lithium/proton exchange process, lithium in the heat treated lithium titanate is exchanged with protons. In other words, the heat treated lithium titanate is dipped in an acid aqueous solution, and proton exchange reaction is applied, so that the proton exchanger of lithium titanate can be obtained in which almost all lithium in the heat treated lithium titanate is exchanged with hydrogen. In this case, it is preferred to disperse and keep the lithium titanate in the acid aqueous solution for a certain period of time, and then to separate the same by filtration, centrifugation, or the like, and to dry the same.

The acid used in the lithium/proton exchange process is preferably an arbitrary concentration of aqueous solution containing one or more types of hydrochloric acid, sulfuric acid, and nitric acid, and more preferably a diluted hydrochloric acid having a concentration of 0.1 to 1.0 N. The process time of exchanging lithium with protons is 10 hours to 10 days, preferably 1 to 7 days. The process temperature of exchanging lithium with protons is preferably room temperature (20 degrees Celsius) or higher and lower than 100 degrees Celsius.

Drying of the proton exchanger of lithium titanate can be performed by a known method using a box type dryer, a spray dryer, or the like. Note that it may be possible to add and mix conductive agent such as carbon to the proton exchanger before drying. Adding and mixing the conductive agent can be performed by a method of slurrying the proton exchanger, and stirring and mixing the same, or other method. If necessary, it may be possible to add a dispersant or to use a disperser.

In the proton exchanger heat treatment process, the proton exchanger of lithium titanate obtained by the lithium/proton exchange process is heat treated. By the heat treatment, dehydration reaction of the proton exchanger proceeds, and titanium oxide H₂Ti₁₂O₂₅ is obtained. The heat treatment can be performed in the air, in an inert gas atmosphere such as nitrogen or argon, in an atmosphere containing hydrogen gas, or under reduced pressure, but in an inert gas atmosphere or in a reduced pressure atmosphere is preferred. In addition, the temperature of the heat treatment is preferably 200 degrees Celsius or higher and 600 degrees Celsius or lower, and more preferably 260 degrees Celsius or higher and 500 degrees Celsius or lower. The heat treatment time is usually 0.5 to 100 hours, and preferably 1 to 30 hours. Firing in the atmosphere containing oxygen or firing at high temperature of 600 degrees Celsius or higher will promote production of anatase, rutile, or the like as a side reaction, and hence it is preferred to perform the firing in the heat treatment atmosphere, temperature, and time described above.

It is sufficient that H₂Ti₁₂O₂₅ obtained by the proton exchanger heat treatment process displays, in a powder XRD measurement using Cu-Kα as a ray source, a peak at the same peak position as JP-A-2008-255000. In addition, a peak intensity ratio may be different. The peak intensity ratio varies due to refinement of primary particles, which causes poor crystal growth on a specific crystal face. In particular, a peak derived from the (110) surface appearing near 25 degrees or a peak derived from the (020) surface appearing near 48 degrees may become hard to discriminate, because the intensity thereof is largely weakened or it overlaps with a neighboring peak.

In addition, there is a case where a small amount of titanium dioxide such as anatase or rutile is contained as impurity in H₂Ti₁₂O₂₅, but the little amount of it hardly affects battery characteristics of H₂Ti₁₂O₂₅. The amount of the titanium dioxide contained in H₂Ti₁₂O₂₅ is calculated as a ratio I₁/I₀ between a peak height I₀, which appears near 28 degrees of the (003) surface of the H₂Ti₁₂O₂₅ determined by the powder XRD measurement, and a peak height I₁ of the main peak of the titanium dioxide (the (101) surface appearing near 25 degrees in anatase, or the (110) surface appearing near 27 degrees in rutile). Note that the peak height is a height of the peak point from the base that is a straight line connecting minimum height points before and after the peak. I₁/I₀ of H₂Ti₁₂O₂₅ is preferably 5 or less, and more preferably 3 or less.

The particle shape of H₂Ti₁₂O₂₅ is not particularly limited, but an isotropic shape such as a globular shape or a polyhedral shape is preferred in order to enhance packing density of the negative electrode layer.

In addition, the particle shape of H₂Ti₁₂O₂₅ is preferably a secondary particle shape in which the primary particles are aggregated. When it is the secondary particle shape, handling and powder characteristics such as flowability, adhesive property, or filling property of H₂Ti₁₂O₂₅ as the active material is improved in production of the negative electrode layer of the lithium ion battery, and battery characteristics can be improved more. The preferred range of the average secondary particle size D50 is 1 to 15 μm, while that of D90 is less than 50 μm. If the secondary particle size D50 is less than 1 μm, dispersibility when producing the electrode paste is deteriorated. On the other hand, if the secondary particle size D90 is more than 50 μm, smoothness of the electrode sheet may be impaired, or a ratio of H₂Ti₁₂O₂₅ that is not affected by contribution of electron conductivity due to carbon coating may be increased. The specific surface area depending on the particle size is preferably 15 m²/g or more and 150 m²/g or less. If it is less than 15 m²/g, the primary particle size is increased, and current density when constituting the battery is increased, and hence the input and output characteristics are lowered. On the other hand, if it is more than 150 m²/g, the bulk density of HTO becomes too large, and hence the binder amount must be increased in order to maintain the mechanical strength. In addition, capacity decrease due to electrode density decrease is increased. The method for granulating the secondary particles is preferably a method of spray drying the slurry containing the proton exchanger of lithium titanate using a spray dryer or the like.

(3-1-2) Mixing of Single wall Carbon Nanotubes

The method for mixing and adhering the single wall carbon nanotubes to H₂Ti₁₂O₂₅ can be a method of wet mixing the single wall carbon nanotubes in the process where H₂Ti₁₂O₂₅ or proton exchanger of lithium titanate obtained in the previous process is slurried when producing H₂Ti₁₂O₂₅, and simultaneously drying them, or other method. In order to allow the single wall carbon nanotubes to disperse and adhere to particles of H₂Ti₁₂O₂₅ more uniformly, it is preferred to adopt the method of wet mixing in the slurry and simultaneously drying them.

In particular, it is preferred to slurry the proton exchanger in the process just before drying the proton exchanger of lithium titanate, to stir and mix the single wall carbon nanotubes, to spray dry the same by a spray dryer or the like, and to mix and adhere the single wall carbon nanotubes to particle surfaces of the proton exchanger of lithium titanate.

When adding the single wall carbon nanotubes to the slurry of the proton exchanger of lithium titanate, it may be possible to add a dispersant or a surface acting agent, or to adopt simultaneous dispensing using a wet type bead mill or a medialess disperser.

The containing amount or carrying amount of the single wall carbon nanotubes is not particularly limited, but it is preferably 0.3 weight percent or more and 5 weight percent or less with respect to H₂Ti₁₂O₂₅. If it is less than 0.3 weight percent with respect to H₂Ti₁₂O₂₅, the input and output can be obtained only the same or less degree than the case where the conventional agent is added to the electrode. If it is more than 5 weight percent, concentration of the negative electrode active material becomes relatively low, and hence capacity is decreased, and simultaneously, adhesive strength is lowered while conductivity is decreased. On the other hand, if the binder amount is increased for the purpose of improving strength, capacity is further decreased.

### (3-2) Method for Producing Battery

Hereinafter, a method for producing a battery having the structure of this embodiment is described.

The binder for the negative electrode of H₂Ti₁₂O₂₅ in which the single wall carbon nanotubes are contained or carried can be, for example, polyvinyl alcohol, polyacrylic acid, styrene-butadiene rubber (SBR), carboxymethyl cellulose (CMC), hydroxypropyl cellulose, polyvinyl chloride, polyvinyl pyrolidone, polytetrafluoroethylene (PTFE), polyvinylidene fluoride (PVDF), polyamide-imide, or polyamide. Only one of them may be used, or two or more of them may be used simultaneously. The conductive agent is not necessary basically. However, as the electron conductivity of the single wall carbon nanotubes is limited between neighboring particles, in order to assist long-distance conductivity over a plurality of particles, it may be possible to mix carbon black such as acetylene black or ketjen black, VGCF (registered trademark), or the like.

As the active material for the positive electrode, a transition metal composite oxide containing lithium (lithium-contained transition metal composite oxide) is used, which can store and release lithium ions. The lithium-contained transition metal composite oxide can be LiCoO₂, LiNiO₂, LiNiCoMnO₂, LiMn₂O₄, or the like, which has a layered structure. Only one of them may be used, or two or more of them may be used simultaneously. The binder can be polyvinyl alcohol, polyacrylic acid, polyvinyl pyrolidone, polytetrafluoroethylene (PTFE), PVDF, polyamide-imide, or polyimide. Only one of them may be used, or two or more of them may be used simultaneously. The conductive agent can be, for example, carbon black such as acetylene black or ketjen black, single wall carbon nanotubes, or the like. Only one of them may be used, or two or more of them may be used. These positive electrode active material, the binder, the conductive agent, and the like are dispersed in a solvent such as N-methyl-2-pyrolidone (NMP), which is applied onto one side or both sides of a charge collector, and after drying, a pressing process such as a calender process is carried out for production. However, the method for producing the positive electrode is not limited to the above method, but it may be produced by other method. The charge collector can be made of aluminum, aluminum alloy, stainless steel, or the like, which are known conventionally. The thickness of the charge collector is not particularly limited, and it is usually 1 to 50 μm.

### (3-2-1) Example of Battery Structure

The nonaqueous electrolyte secondary battery of this embodiment may include a positive electrode, a negative electrode, a separator, and a nonaqueous electrolyte.

The nonaqueous electrolyte can be an electrolytic solution prepared by dissolving lithium salt in an organic solvent. The organic solvent can be ethylene carbonate (EC), propylene carbonate (PC), butylene carbonate (BC), vinylene carbonate (VC), dimethyl carbonate (DMC), diethyl carbonate (DEC), methylethyl carbonate (MEC), γ-butyrolactone, 1,2-dimethoxyethane, tetrahydrofuran, 2-methyltetrahydrofuran, 1,3-dioxolan, dimethyl formamide, dioxolane, or acetonitrile. Only one of them may be used, or two or more of them may be used simultaneously. The lithium salt can be LiClO₄, LiBF₄, LiPF₆, LiCF₃SO₃, LiCF₃CO₂, LiAsF₆, or the like. Only one of them may be used, or two or more of them may be used. In addition, for the purpose of improving cycle or the like, it may be possible to contain 3-propane sultone, diphenyl disulfide, cyclohexylbenzene, or vinylene carbonate. The separator can be polyolefin microporous membrane made of polyethylene (PE), polypropylene (PP), or the like, or nonwoven fabric made of cellulose or the like. In addition, it may be possible to use a laminated type separator constituted of a porous layer mainly containing an inorganic filler.

### (3-2-2) Form of Battery

The form of the nonaqueous electrolyte secondary battery according to this embodiment is not particularly limited. The nonaqueous electrolyte secondary battery according to this embodiment may have any form such as a coin shape, a button shape, a sheet shape, a laminated shape, a cylindrical shape, a flat shape, a square shape, a large type used for electric vehicles or the like.

### EXAMPLES

Hereinafter, the method for producing the battery according to the embodiment is described in detail, but the claimed invention is not limited to these.

### Example 1

### (Production of Positive Electrode Electrode)

LiNiCoMn(5:2:3)O₂ as the positive electrode active material, carbon black as the conductive agent, and PVDF as the binder were applied to aluminum foil so that the weight ratio of them became 96:2:2, which was dried and pressed, and thus the positive electrode was produced. H₂Ti₁₂O₂₅ containing the single wall carbon nanotubes (hereinafter, may be referred to as HTO/SCNT) was synthesized as follows. The containing amount of the single wall carbon nanotubes with respect to H₂Ti₁₂O₂₅ was set to one weight percent.

(Synthesis of Negative Electrode Active Material H₂Ti₁₂O₂₅)

### (Lithium Titanate Synthesis Process)

1,000 g of lithium hydroxide monohydrate (produced by WAKO Pure Chemical industries, Ltd.) and 5,000 mL of ion-exchanged water were put in a titanium hydrothermal reaction vessel having an internal volume of 10 L, and were stirred by a stirrer, and thus the lithium hydroxide monohydrate was all dissolved. Here, 1,000 g of titanium dioxide (SSP-25 produced by Sakai Chemical Industry Co., Ltd., having a crystal form of anatase and a primary particle size of approximately 5 nm) was added, stirred, and mixed, and thus a mixed slurry of titanium oxide and lithium hydroxide monohydrate was obtained. While stirring the mixed slurry, a hydrothermal reaction was performed at 180 degrees Celsius for 24 hours using an autoclave.

The slurry after the hydrothermal reaction was all sucked and filtered using a buchner funnel and 5 C filter paper, and solid content on the filter paper was collected. The collected solid content was resuspended in 0.05 mol/L of hydrochloric acid aqueous solution so that a concentration of approximately 10 g/L can be obtained, and stirring was continued for one hour. After that, using the buchner funnel and the 5 C filter paper, whole suction and filtration was performed, and solid content on the filter paper was collected. The solid content after filtration was put in a magnetic dish and was dried in a box type dryer set at temperature of 130 degrees Celsius for a whole day and night. The dried solid matter was shredded by a dry coffee mill, and thus lithium titanate was obtained.

### (Lithium Titanate Heat Treatment Process)

The lithium titanate described above was put in an alumina firing vessel and was heated using a box type firing furnace in the air at a temperature increase rate of 200 degrees Celsius per hour up to 300 degrees Celsius. After keeping it at 300 degrees Celsius for five hours, it was naturally cooled to the room temperature in the furnace, and thus a heat treated product of lithium titanate was obtained.

Crystal phase of the heat treated product of lithium titanate was identified using a powder X-ray diffractometer (RINT TTR-III manufactured by Rigaku, using an X-ray source of CuKα), and it was confirmed to have a mixed structure of the rock salt type crystal structure and the monoclinic crystal structure of Li₂TiO₃.

### (Lithium/Proton Exchange Process of Heat Treated Product of Lithium Titanate)

The heat treated product of lithium titanate was suspended in 0.5 mol/L hydrochloric acid aqueous solution so as to have a concentration of approximately 25 g/L, and was continuously stirred using a stirrer for 12 hours. After the stirring was stopped, it was further left at rest for approximately 12 hours. The slurry after the still standing was sucked and filtered using the buchner funnel and the 5 C filter paper, and thus a solid content was obtained. The obtained solid content was resuspended in the ion-exchanged water and was sucked and filtered again for washing with water. Eventually, the washing process was repeated until conductivity of the filtrate became lower than 100 μS/cm.

The proton exchanged product corresponds to a composite of H₂TiO₃ because lithium in Li₂TiO₃ was exchanged by protons. When the proton exchanger is heat treated, dehydration occurs and H₂Ti₁₂O₂₅ is formed. In order to calculate containing amount of H₂Ti₁₂O₂₅ in the washed solid content (cake), a small amount of the solid content was weighed and put in a porcelain crucible, and was dried in a box type dryer at a temperature of 130 degrees Celsius for one night, and further was fired in an atmosphere firing furnace in a nitrogen flow, at a temperature of 350 degrees Celsius for five hours. After cooling to the room temperature, it was taken out of the firing furnace and was weighed. The containing amount (concentration) of H₂Ti₁₂O₂₅ in the washed solid content is given by the following formula 1.

$$containing amount ( concentration ) of {H}_{2} {Ti}_{12} {O}_{25} = fired powder weight ( g ) / washed solid content weight ( g ) \times 100 ( \% ) \qquad Formula 1$$

After lightly shredding the fired powder in a mortar, the specific surface area of H₂Ti₁₂O₂₅ was measured using a one point BET method (with Macsorb HM-1220 manufactured by Mountech Co., Ltd.). The obtained specific surface area of H₂Ti₁₂O₂₅ was 62 m²/g.

In addition, the crystal phase was identified by a powder X-ray diffraction method (with RINT TTR-III manufactured by Rigaku using an X-ray source of CuKα). The obtained diffraction pattern was attributed to H₂Ti₁₂O₂₅ and anatase TiO₂. The ratio I₁/I₀ between the peak height I₀ that appears near 28 degrees of the (003) surface of H₂Ti₁₂O₂₅ and the peak height I₁ that appears near 25 degrees of the (101) surface of anatase TiO₂ was 0.7.

### (Mixing of Single Wall Carbon Nanotubes)

The washed solid content (cake) was suspended and stirred in the ion-exchanged water so that H₂Ti₁₂O₂₅ had a concentration of approximately 200 g/L, and thus slurry of the proton exchanger was produced. Furthermore, polyacrylic acid ammonium dispersant (Dispersant A40 produced by KF Chemicals, Ltd.) as a dispersant was added by 5 weight percent with respect to the solid content, and was stirred. The slurry was allowed to pass through a standard sieve made of SUS having apertures of 45 μm, and it was confirmed that there was no residue on the sieve. Single carbon nanotube dispersion liquid produced by Kusumoto Chemicals, Ltd. was weighed to be one weight percent with respect to H₂Ti₁₂O₂₅ by solid content conversion, and was added to the slurry, which was stirred continuously for one hour.

The mixed slurry of the proton exchanger and the single wall carbon nanotubes was dry granulated using a spray dryer (four-fluid nozzle type micro mist spray dryer MDL-050M manufactured by Fujisaki Electric Co., Ltd.). The operation conditions were a hot wind inlet temperature of 250 degrees Celsius, an outlet temperature of 110 degrees Celsius, and air quantity of 30 L/min.

### (Heat Treatment Process of Proton Exchanger)

The obtained mixed granulated powder of the proton exchanger and the carbon nanotubes were fired in the atmosphere firing furnace in the nitrogen flow at a temperature of 350 degrees Celsius for five hours.

### (Measurement of Secondary Particle Size)

The secondary particle size of the mixed fired product (HTO/SCNT) of H₂Ti₁₂O₂₅ and the carbon nanotubes, which was obtained by the above process, was measured using a laser diffraction particle size distribution analyzer (LA-950 manufactured by HORIBA, Ltd.). As a dispersion medium, 0.025% sodium hexametaphosphate was used. Ultrasonic dispersion of LA-950 main body was carried out for one minute, and refractive constant was set to 2.52. The particle size distribution measured by the particle size distribution analyzer displayed a single peak distribution approximately from 0.5 to 20 μm, in which D50 was 2.6 μm and D90 was 8.1 μm. Note that, as definitions of D50 and D90 of the particle size distribution, in a volume basis particle size distribution, a particle size at 50% from small size was expressed as D50, and a particle size at 90% from the same was expressed as D90. Here, a measured value of the particle size distribution was expressed as a secondary particle size because it is not dispersed in the primary particles but reflects an aggregation state. In addition, the particle shape was observed using a scanning electron microscope (JSM-7000F manufactured by JEOL Ltd.). It was confirmed that approximately 1 to 10 μm granulated secondary particles were formed.

### (Production of Negative Electrode)

HTO/SCNT produced in this way was applied to Cu foil using SBR and CMC as the binders so that the weight ratio of them became 97:1:2, which was dried and pressed, and thus the negative electrode was produced.

### (Production of Card Type Cell)

The electrodes were cut into a predetermined size, and were laminated via polyethylene separators, and were wrapped with resin laminated aluminum foil. Next, 1 Mol/LiPF₆/EC:DEC(3:7) as electrolytic solution was injected into the wrapping container, which was sealed, and thus a card type cell was produced. In this cell, the ratio of the negative electrode capacity to the opposing positive electrode capacity was set to 0.9, and hence the cell capacity was restricted by the positive electrode capacity.

### Example 2

LiNiCoMn(5:2:3)O₂ as the positive electrode active material, carbon black as the conductive agent, and PVDF as the binder were applied to AL foil so that the weight ratio of them became 96:2:2, which was dried and pressed, and thus the positive electrode was produced. As the negative electrode active material, HTO/SCNT was synthesized in the same manner as in Example 1, except that the additive amount of the single wall carbon nanotubes was set to 0.5 weight percent with respect to H₂Ti₁₂O₂₅, in the mixing process of the single wall carbon nanotubes in synthesis of H₂Ti₁₂O₂₅ of Example 1.

The obtained HTO/SCNT was applied to the AL foil using PVDF as the binder, and thus the negative electrode was produced. The weight ratio (HTO/SCNT)/PVDF was set to 96/4. After that, similarly to Example 1, the card type cell was produced.

### Example 3

LiNiCoMn(5:2:3)O₂ as the positive electrode active material, carbon black as the conductive agent, and PVDF as the binder were applied to AL foil so that the weight ratio of them became 96:2:2, which were dried and pressed, and thus the positive electrode was produced. As the negative electrode active material, HTO/SCNT was synthesized in the same manner as in Example 1, except that the additive amount of the single wall carbon nanotubes was set to 3 weight percent with respect to H₂Ti₁₂O₂₅, in the mixing process of the single wall carbon nanotubes in synthesis of H₂Ti₁₂O₂₅ of Example 1.

The obtained HTO/SCNT was applied to the AL foil using PVDF as the binder, and thus the negative electrode was produced. The weight ratio (HTO/SCNT)/PVDF was set to 96/4. After that, similarly to Example 1, the card type cell was produced.

### Comparative Example 1

H₂Ti₁₂O₂₅ was synthesized in the same procedure as in Example 1, except that the single wall carbon nanotubes were not added in the mixing process of the single wall carbon nanotubes in synthesis of H₂Ti₁₂O₂₅ of Example 1.

The electrode and the battery were produced in the same manner as in Example 1 except that the negative electrode was used in which the weight ratio of H₂Ti₁₂O₂₅, the single wall carbon nanotubes, SBR, and CMC was set to 96:1:1:2.

### Comparative Example 2

The electrode and the battery were produced in the same manner as in Comparative Example 1 except that the negative electrode was used in which the weight ratio of H₂Ti₁₂O₂₅, acetylene black, and PVDF was set to 80:10:10.

### Comparative Example 3

The electrode and the battery were produced in the same manner as in Comparative Example 1 except that the negative electrode was used in which the weight ratio of H₂Ti₁₂O₂₅, acetylene black, SBR, and CMC was set to 90:5:2:3.

### Comparative Example 4

The electrode and the battery were produced in the same manner as in Example 1 except that multi-walled carbon nanotube dispersion liquid was used instead of the single carbon nanotube dispersion liquid.

### Comparative Example 5

The electrode and the battery were produced in the same manner as in Example 1 except that the containing amount of the single wall carbon nanotubes was set to 0.2 weight percent.

### Comparative Example 6

The electrode and the battery were produced in the same manner as in Example 1 except that the containing amount of the single wall carbon nanotubes was set to 6 weight percent.

### Comparative Example 7

LiNiCoMn(5:2:3)O₂ as the positive electrode active material, carbon black as the conductive agent, and PVDF as the binder were applied to AL foil so that the weight ratio of them became 96:2:2, which was dried and pressed, and thus the positive electrode was produced. H₂Ti₁₂O₂₅ (HTO/SCNT) containing single wall carbon nanotubes was synthesized as follows. The containing amount of the single wall carbon nanotubes with respect to H₂Ti₁₂O₂₅ was set to 1 weight percent.

As the negative electrode active material, H₂Ti₁₂O₂₅ was synthesized in the same manner as in Example 1 except that titanium dioxide (R-310 produced by Sakai Chemical Industry Co., Ltd., having crystal form of rutile, and primary particle size of approximately 150 nm) was used as the titanium raw material, in the lithium titanate synthesis process in synthesis of H₂Ti₁₂O₂₅ of Example 1. The specific surface area of H₂Ti₁₂O₂₅ was 10 m²/g. In addition, the diffraction pattern obtained by the powder X-ray diffraction method was attributed to H₂Ti₁₂O₂₅, anatase TiO₂, and rutile TiO₂. The ratio I₁/I₀ between the peak height I₀ that appears near 28 degrees of the (003) surface of H₂Ti₁₂O₂₅ and the peak height I₁ that appears near 25 degrees of the (101) surface of anatase TiO₂ was 4.8. In addition, the ratio I₁/I₀ of the peak height I₁ that appears near 27 degrees of the (110) surface of rutile TiO₂ was 2.9.

Mixing of H₂Ti₁₂O₂₅ and the single wall carbon nanotubes was carried out in the same manner as in Example 1. The particle size distribution of the obtained HTO/SCNT displayed a double peak distribution approximately from 0.1 to 30 μm, in which D50 was 0.7 μm and D90 was 9.3 μm.

HTO/SCNT produced in this way was applied to Cu foil using SBR and CMC as the binders so that the weight ratio of them became 97:1:2, which was dried and pressed, and thus the negative electrode was produced, but the coating film came off from the Cu foil a lot. Therefore, CMC amount was increased to be 93:1:6, and thus the electrode was produced. After that, in the same manner as in Example 1, the electrode and the battery were produced.

### Comparative Example 8

LiNiCoMn(5:2:3)O₂ as the positive electrode active material, carbon black as the conductive agent, and PVDF as the binder were applied to AL foil so that the weight ratio of them became 96:2:2, which was dried and pressed, and thus the positive electrode was produced. H₂Ti₁₂O₂₅ (HTO/SCNT) containing the single wall carbon nanotubes was synthesized as follows. The containing amount of the single wall carbon nanotubes with respect to H₂Ti₁₂O₂₅ was set to 1 weight percent.

As the negative electrode active material, in the mixing process of the single wall carbon nanotubes in synthesis of H₂Ti₁₂O₂₅ of Example 1, the slurry in which the proton exchanger and the single wall carbon nanotubes were mixed was sucked and filtered using the buchner funnel and the 5 C filter paper, and solid content on the filter paper was collected. The solid content after filtration was dried in a box type dryer set at temperature of 130 degrees Celsius for one night, and the dried solid matter was shredded by a dry coffee mill, and thus HTO/SCNT was obtained. The particle size distribution of the obtained HTO/SCNT displayed a double peak distribution approximately from 0.5 to 300 μm, in which D50 was 3.8 μm and D90 was 56.8 μm.

HTO/SCNT produced in this way was applied to Cu foil using SBR and CMC as the binders so that the weight ratio of them became 97:1:2, which was dried and pressed, and thus the negative electrode was produced. Two-dimensional continuity of the coating film was lowered, a variation in application amount was increased, and in-plane uniformity was lowered. After that, similarly to Example 1, the electrode and the battery were produced.

### Comparison Between Example and Comparative Example

For each battery of these Examples and Comparative Examples, 3V 0.2 C CCCV charging and 1V final 0.2 C discharging were carried out three cycles. Then, after 3V 1 C CCCV charging, and then after 1V final 20 C discharging and 1V 0.2 C CCCV discharging, 3V 20 C CCCV charging was carried out. Table 1 shows an initial discharge capacity, a ratio of 20 C discharge capacity to 0.2 C discharge capacity as output evaluation, and a ratio of CC charge capacity to total charge capacity in 20 C charging as input evaluation. In each Example, 60% or more 20 C input and output were obtained, and 70 mAh or more capacity was obtained. In contrast, in Comparative Example 1 in which single wall carbon nanotubes were just mixed, input and output was decreased. In Comparative Example 2 or 3 in which other conductive agent was used, it was remarkably decreased, and the initial capacity was also low. In Comparative Example 4 in which the multi-walled carbon nanotubes were used in synthesis, no improvement of input and output was observed. On the other hand, in Comparative Example 5 in which containing amount in synthesis was low, the effect was hardly obtained. On the contrary, in Comparative Example 6 in which containing amount was too high, decrease in adhesive strength between the active material layer and the Al charge collector was considered to cause decrease in conductivity, resulting in decrease in capacity and decrease in input and output. In Comparative Example 7, the primary particle size of HTO was increased, and the specific surface area was decreased while current density was increased. Therefore, insertion/extraction of lithium ions inside the active material particles due to discharge and charge became slow, resulting in significant decrease in the initial capacity and in the 20 C input and output. In Comparative Example 8, the 20 C input and output was decreased due to influence of variation in application amount to the negative electrode.

TABLE 1
Initial Capacity and Input/output Characteristics
of Examples and Comparative Examples

| | Initial | 20 C | 20 C |
|---|---|---|---|
| | Capacity (mAh) | output (%) | input (%) |
| Example 1 | 72 | 63 | 64 |
| Example 2 | 75 | 66 | 68 |
| Example 3 | 72 | 68 | 72 |
| Comparative Example 1 | 68 | 56 | 58 |
| Comparative Example 2 | 52 | 3 | 10 |
| Comparative Example 3 | 58 | 8 | 16 |
| Comparative Example 4 | 70 | 18 | 22 |
| Comparative Example 5 | 65 | 34 | 43 |
| Comparative Example 6 | 62 | 47 | 51 |
| Comparative Example 7 | 51 | 12 | 21 |
| Comparative Example 8 | 60 | 43 | 47 |

1. A nonaqueous electrolyte secondary battery comprising:
a positive electrode containing a lithium-containing transition metal composite oxide as an active material;
a negative electrode; and
a nonaqueous electrolyte,
wherein the negative electrode contains titanium oxide particles that are particles of titanium oxide represented by general formula H₂Ti₁₂O₂₅, a binder, and 0.3-5.0 weight percent of single wall carbon nanotubes with respect to the titanium oxide, and
the titanium oxide particles have a secondary particle size D50 of 1 to 15 μm and a secondary particle size D90 of 50 μm or less.

2. The nonaqueous electrolyte secondary battery according to claim 1, wherein the titanium oxide particles have a specific surface area of 15 to 150 m²/g.
